(19) United States
(12) Patent Application Publication
(10) Pub. No.: US 2004/0255274 A1
(43) Pub. Date: Dec. 16, 2004

(54) Test system with flexible extension and maintenance functions and the method thereof

(76) Inventors: Win-Harn Liu, Taipei (TW); Jeff Song, Taipei (TW); Hsin Liu, Tianjin (CN)

Correspondence Address: BIRCH STEWART KOLASCH & BIRCH, PO BOX 747, FALLS CHURCH, VA, 22040-0747, US

(21) Appl. No.: 10/459,451

(22) Filed: Jun. 12, 2003

(51) Int. Cl. G09G 5/00; G06F 9/44

(52) U.S. Cl. 717/124

(57) ABSTRACT

A test system with flexible extension and maintenance functions and the associated method are disclosed. In the existing procedure of apparatus test operations, independent system structures and functional modules are employed to separate the extension and maintenance of test programs, the organization of the test procedure, and the test operation of apparatuses. Therefore, these modules become completely independent, raising the stability and extensibility of the test system. By this system and method thereof can also increase the efficiency and flexibility of the test operation.

### BACKGROUND OF THE INVENTION

1. Field of Invention

The invention relates to an enterprise electronic operation platform. In particular, the invention pertains to a test system for performing test operations which has independent modules for extending and maintaining the program, for designing the procedure structure, and for testing the apparatus. The invention can provide a more stable, flexible and efficient test system and the associated method.

2. Related Art

In the wake of a modern network era where information plays an important role in economics, every enterprise more urgently wants to increase the management efficiency and to save the business running cost by having a fully electronic management operation platform inside the company. This trend seems to become a golden rule for a business to succeed today and the future. Only through an entirely electronic management operation mechanism can resources within an enterprise be shared and information be exchanged, giving the business more competitive power.

The test operation is always a major problem that has long been bothering each business. As the test apparatuses often involve complicated procedures and need to be replaced, the extension of relevant test programs and the maintenance of the test procedure faces a lot of difficulty. The test operation was not noticed in the past about its posiible future development. Therefore, its flexibility and extensibility have never been taken into account when designing the system structure and funcitonal modules. A consequence is that one often needs to repeat the research and development, inevitably resulting in a big consumption of various resources in the business.

It is thus an important topic to design a test system and method that have independently running hardware structures and independent operating functional modules for the enterprises to increase the efficiency and flexibility in the test operation and, in the end, to enhance their competitive power.

### SUMMARY OF THE INVENTION

In view of the foregoing, the invention provides a test system and method with flexible extension and maintenance functions. An objective of the invention is to design an independent system structure for the extension and maintenance of test programs, the design and organization of the test procedure, and the test of apparatuses. Each of these functions is modulized so that they can run independently. This achieves the objective of making the test operation more stable, flexible and efficient.

### BRIEF DESCRIPTION OF THE DRAWINGS

The invention will become more fully understood from the detailed description given hereinbelow illustration only, and thus are not limitative of the present invention, and wherein:

FIG. 1 shows the system structure of the disclosed test system with flexible extension and maintenance;

FIG. 2 is a flowchart of the disclosed test method with flexible extension and maintenance;

FIG. 3 is a flowchart of the procedure organization and design according to the invention;

FIG. 4 is a flowchart of the apparatus testing according to the invention; and

FIG. 5 is a schematic view of the operating interfaces in the invention.

### DETAILED DESCRIPTION OF THE INVENTION

The invention discloses a test system and method with flexible extension and maintenance functions. Through the disclosed test system 200, different users (such as programmers, test personnel, etc) are allowed to perform operations of different functions through operating interfaces (e.g. operating interface a 40, operating interface b 50, operating interface c 60, etc). Such operations include the extension and maintenance of test programs through a development interface, the organization and design of the test procedure through an editing interface, and the test operation of different apparatuses (e.g. apparatus a 10, apparatus b 20, apparatus c 30, etc) through an operating interface.

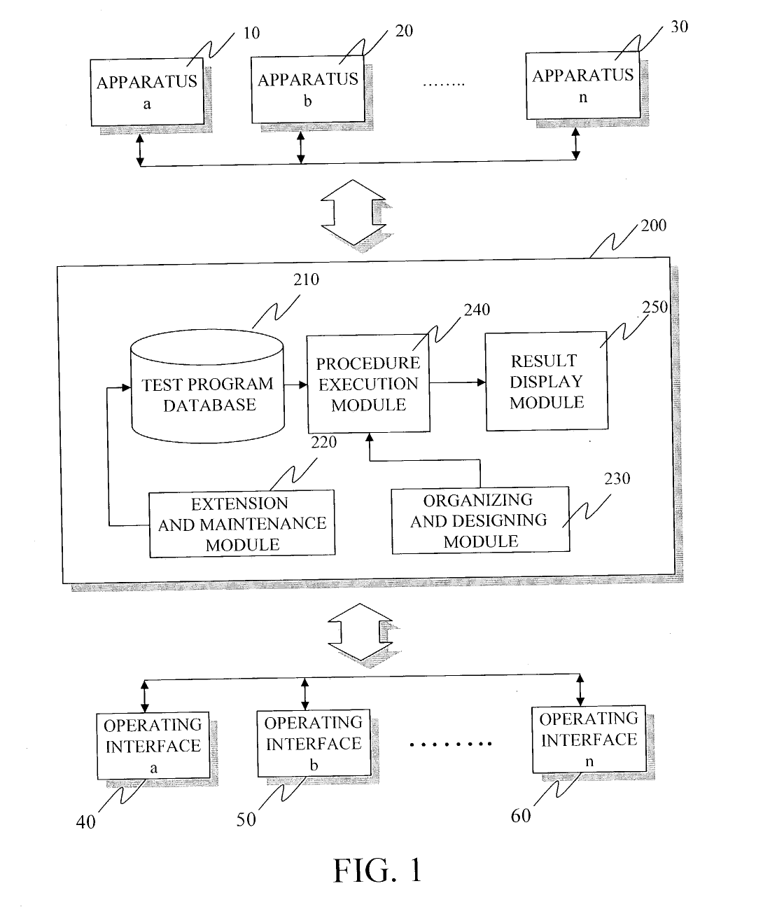

In the following paragraphs, we use FIG. 1 to explain the main structure and functional modules of the disclosed test system 200. The test system 200 includes a test program database 210, an extension and maintenance module 220, an organizing and designing module 230, a procedure execution module 240, and a result display module 250.

(1) The test program database 210 stores test programs necessary for all kinds of apparatuses. All the test programs are filed according to the apparatuses they are testing and the testing contents. The storage locations and the association relations are stored in a procedure-program correspondence table in the procedure execution module 240.

(2) The extension and maintenance module 220 provide a development interface for the user to perform and/or operate new function development (including creation, modification, and deletion). The development interface provides a standard application program interface (API) and functions for the user to develop a desired test program satisfying all test operation standards.

(3) The organizing and designing module 230 provides an editing interface for the user to perform editing on the test procedure (similarly including creation, modification, and deletion). The editing interface provides all executable test contents for the user to define different test contents and test procedures for different apparatuses through the drag-n-drop function.

(4) The procedure execution module 240 is mainly used to store test procedures for all apparatuses. It also provides an operating interface for the user to selected a desired test procedure. In addition, the procedure execution module 240 also has a procedure-program correspondence table, which stores fields of procedure names, procedure function explanations, associated program names, and associated program locations. When a test procedure is running, the correspondence table is used to obtain the appropriate test program from the test program database 210.

In fact, the above-mentioned procedure execution module 240 allows the user to simultaneously perform many different test procedures on one apparatus. The implementation is performed through batch processing. Therefore, the user can flexibly make adjustment on the test procedure.

(5) The result display module 250 shows the test results for each apparatus for the user to clearly understand the status of each apparatus.

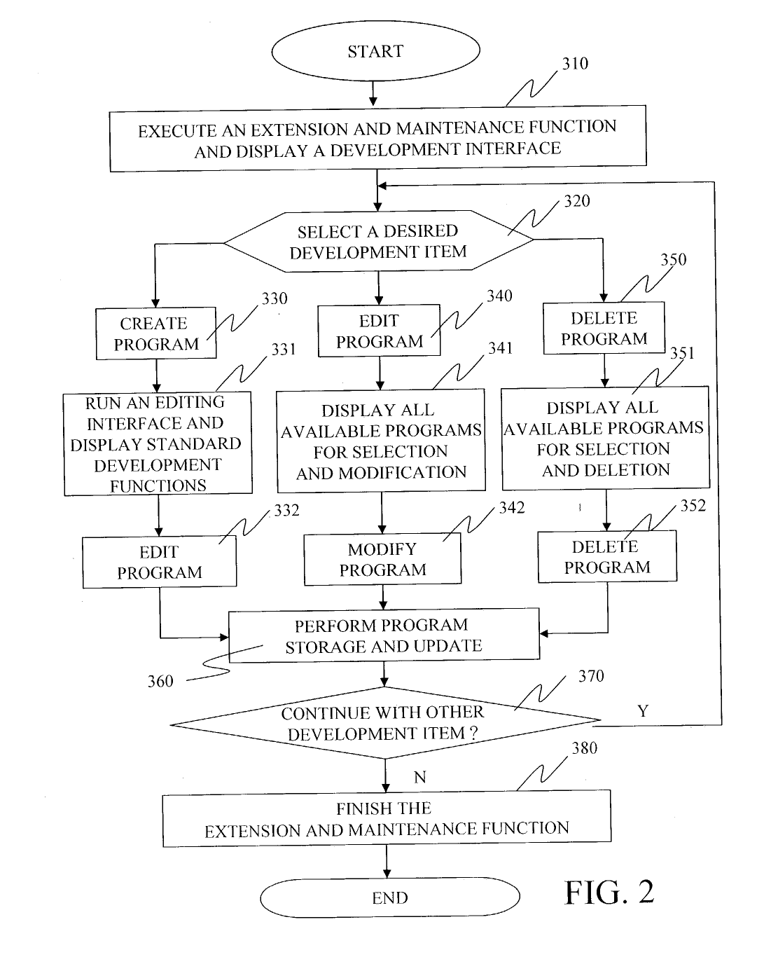

The procedure of developing a test program is explained using FIG. 2. First, the user chooses the extension and maintenance function on the disclosed test system 200 through an operating interface (e.g. operating interface a 40, operating interface b 50, and operating interface c 60) and the system generates and displays a development interface (step 310). The user can then select whatever functions to be developed (step 320). The selection menu includes: creating a program (step 330), modifying a program (step 340), and deleting a program (step 350). If the user selects to create a program (step 330), then the system generates a standard API and standard development items for the user to edit (step 331). Afterwards, the user can start to write the program (step 332). If the user chooses to modify a program (step 340), the system displays all test programs for the user to select and modify (step 341). The user then selects a desired program to modify (step 342). If the user selects to delete a program (step 350), the system displays all test programs for the user to select delete (step 351). The user then perform program deletion (step 352). After the user completes any of the development items, the system performs the test program storage and update operation (step 360). The system further prompts to ask the user whether he/she wants to continue with other development items (step 370). If the user wants to continue, the system returns to step 320; otherwise, the extension and maintenance task is over and the procedure ends (step 380).

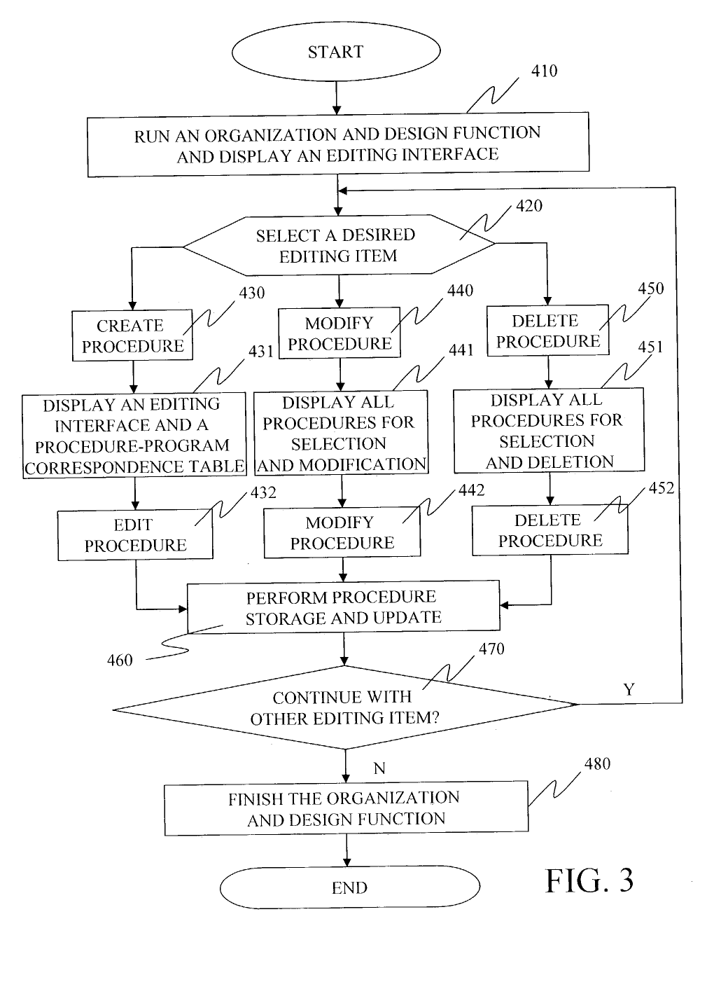

The procedure of editing a test program is explained using FIG. 3. First, the user chooses the organizing and designing function on the disclosed test system 200 through an operating interface (e.g. operating interface a 40, operating interface b 50, and operating interface c 60) and the system generates and displays an editing interface (step 410). The selection menu includes: creating a procedure (step 430), modifying a procedure (step 440), and deleting a procedure (step 450). If the user selects to create a procedure (step 430), then the system generates an editing interface and displays the contents of the procedure-program correspondence table (step 431). Afterwards, the user can start to edit the procedure (step 432). If the user selects to modify a procedure (step 440), the system displays all test procedures for the user to select and modify (step 441). The user then modifies the contents in the procedure (step 442). If the user selects to delete a procedure (step 450), the system displays all test procedures for the user to select and delete (step 451). The user then starts to delete the selected procedure (step 452). After the user completes any of the editing items, the system performs the test program storage and update operation (step 460). The system further prompts to ask the user whether he/she wants to continue with other editing items (step 470). If the user wants to continue, the system returns to step 420; otherwise, the organizing and designing task is over and the procedure ends (step 480).

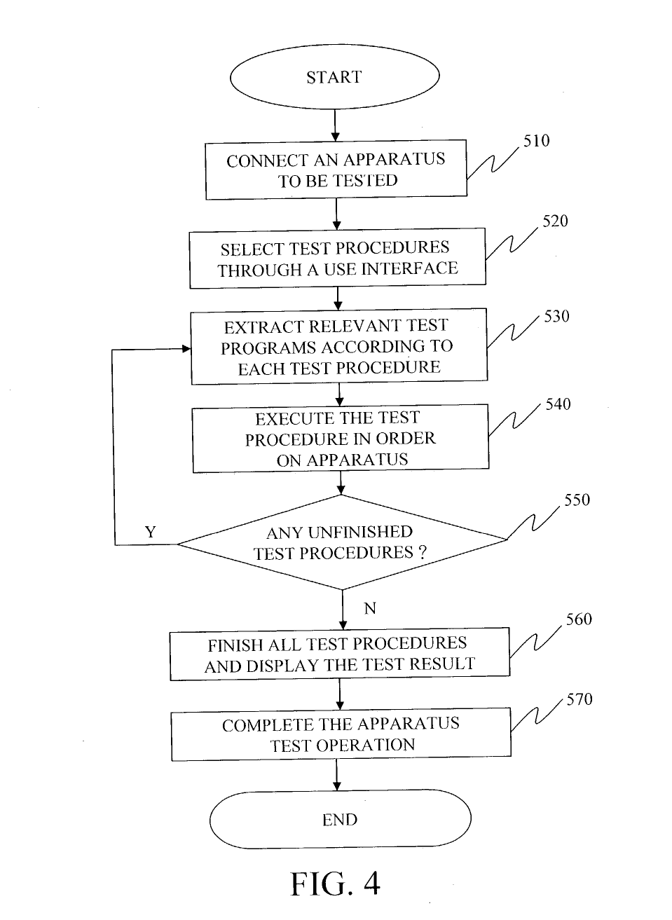

In addition to the flexible test program extension and maintenance and test procedure organization and design, the disclosed test system 200 further provides a method for performing test operations on apparatuses. With reference to FIG. 4, the method is described as follows:

First, the apparatuses to be tested (e.g. apparatus a 10, apparatus b 20, apparatus c 30, etc) are connected to the test system 200 (step 510). The user then uses the operating interface (e.g. operating interface a 40, operating interface b 50, operating interface c 60, etc) generated by the system to select a test procedure to be performed (step 520). Accordingly, the procedure execution module 240 extracts the desired test program from the test program database 210 (step 530). Afterwards, the system runs in order according to the test procedure for each of the apparatuses (step 540). Once a test procedure is completed, the system, determines whether any unfinished test procedure exists to be performed (step 550). If there are unfinished jobs, the system returns to step 530 to carry subsequent test procedures. After all test procedures are done, all test results are displayed for the user's reference (step 560). The apparatus test operation thus finishes (step 570).

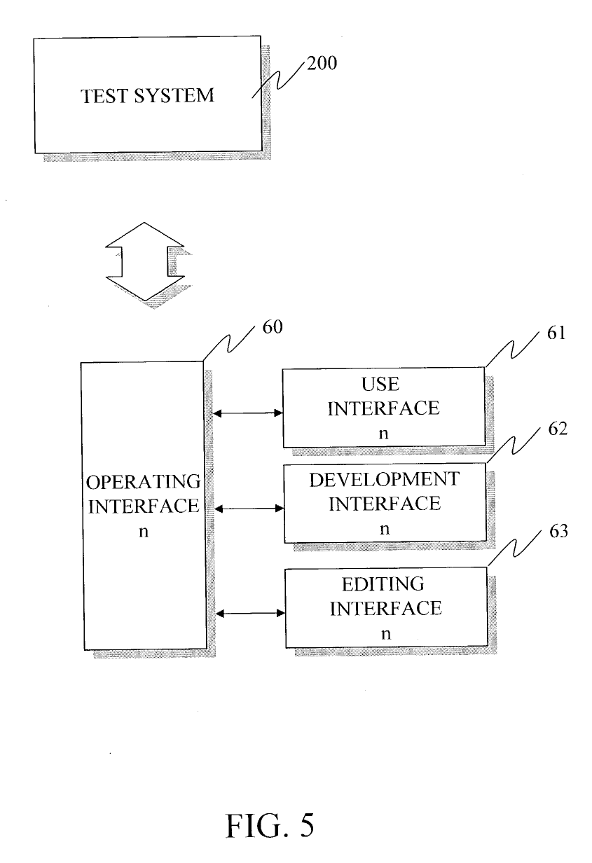

FIG. 5 is a schematic view of various operating interfaces generated when different functions are selected. We take the operating interface n60 as an example. When the user selects to perform the apparatus test operation, the invention generates a use interface n61 in the user operating interface n60. When the user selects to perform the test program extension and maintenance, the invention produces a development interface n62 in the user operating interface n60. If the user selects to organize and design a test procedure, the system generates an editing interface n63 in the user's operating interface n60. Through dedicated interfaces of different functions, the user can quickly accomplish a desired task without difficulty.

### EFFECTS OF THE INVENTION

The disclosed test system with flexible extension and maintenance and the method thereof utilize the design of independent structures. It does not only make the test operation more efficient, but also allows the user to easily accomplish a desired job through the associated specific interface. Moreover, new test operations can be easily created using the invention to satisfy the needs of the enterprise.

What is claimed is:

1. A test system with flexible extension and maintenance for a user to develop and edit test programs for apparatuses during a test process, which test system comprises:
a test program database, which stores test programs for all apparatuses;
an extension and maintenance module, which is used to develop functions for test programs;
a procedure execution module, which stores test procedures for all apparatuses for the user to select and a procedure-program correspondence table for extracting associated test programs from the test program database;
an organizing and designing module, which is used to edit functions for test programs; and
a result display module, which displays a test result for each apparatus being tested.

2. The test system of claim 1, wherein the procedure execution module performs a plurality of test procedures on an apparatus by batch processing.

3. The test system of claim 1, wherein the procedure-program correspondence table includes fields of procedure names, procedure function explanations, associated program names, and locations of associated programs.

4. A test method with flexible extension and maintenance for a user to develop test programs for apparatuses during a test process, which test method comprises:
executing an extension and maintenance function;
selecting a development item;
executing program storage and update; and
finishing the extension and maintenance function.

5. The test method of claim 4, wherein the available development item includes:
creating a program, modifying a program, and deleting a program.

6. The test method of claim 5, wherein the function of creating a program comprises the steps of:
generating an editing interface and displaying development items; and
editing the program.

7. The test method of claim 5, wherein the function of modifying a program comprises the steps of:
displaying all available programs for selection and modification; and
modifying the program.

8. The test method of claim 5, wherein the function of deleting a program comprises the steps of:
displaying all available programs for selection and deletion; and
deleting the program.

9. The test method of claim 4, wherein the test process further comprises the steps of:
connecting an apparatus to be tested;
selecting test procedures;
extracting relevant test programs according to each test procedure;
performing in order the test procedure on the apparatus;
displaying a test result after completing the test procedures; and
finishing the apparatus test operation.

10. The test method of claim 4, wherein the test process performs a plurality of test procedures on an apparatus by batch processing.

11. A test method with flexible extension and maintenance for a user to develop test programs for apparatuses during a test process, which test method comprises:
executing an organizing and designing function;
selecting an editing item;
executing program storage and update; and
finishing the organizing and designing function.

12. The test method of claim 11, wherein the available development item includes:
creating a procedure, modifying a procedure, and deleting a procedure.

13. The test method of claim 12, wherein the function of creating a procedure comprises the steps of:
generating an editing interface and displaying a procedure-program correspondence table; and
editing the procedure.

14. The test method of claim 13, wherein the procedure-program correspondence table includes fields of procedure names, procedure function explanations, associated program names, and locations of associated programs.

15. The test method of claim 12, wherein the function of modifying a procedure comprises the steps of:
displaying all available procedures for selection and modification; and
modifying the procedure.

16. The test method of claim 12, wherein the function of deleting a procedure comprises the steps of:
displaying all available procedures for selection and deletion; and
deleting the procedure.

17. The test method of claim 11, wherein the test process further comprises the steps of:
connecting an apparatus to be tested;
selecting test procedures;
extracting relevant test programs according to each test procedure;
performing in order the test procedure on the apparatus;
displaying a test result after completing the test procedures; and
finishing the apparatus test operation.

18. The test method of claim 17, wherein the test process performs a plurality of test procedures on an apparatus by batch processing.
